(19) United States
(12) Patent Application Publication
(10) Pub. No.: US 2009/0053600 A1
(43) Pub. Date: Feb. 26, 2009

(54) Lithium Battery

(76) Inventor: Stan Battat, Hollywood, FL (US)

Correspondence Address: MCDERMOTT WILL & EMERY LLP, 28 STATE STREET, BOSTON, MA, 02109-1775, US

(21) Appl. No.: 12/063,273

(22) PCT Filed: Aug. 11, 2006
(86) PCT No.: PCT/US06/31374

§ 371 Date: Sep. 15, 2008

Related U.S. Application Data
(60) Provisional application No. 60/707,479, filed on Aug. 11, 2005.

(51) Int. Cl. H01M 4/24; H01M 4/34

(52) U.S. Cl. 429/199; 429/219; 429/220; 429/231.8; 429/231.95; 429/326; 429/337

(57) ABSTRACT

Systems, methods, and apparatus are described for batteries including a positive electrode (14), a negative electrode (16), a separator (18), and an electrolyte (20) contacting the positive and negative electrolyte. The negative electrode can include lithium (Li) in the form of a thin sheet. The positive electrode can include an active material such as copper oxide (CuO), aluminum oxide (Al₂O₃), or silver oxide(Ag₂O) in the form of powder mixed with adhesive materials and/or conductive materials. The active material powder and the additives can be coated on a thin sheet substrate. The separator can be in the shape of a thin sheet, and is sandwiched between the positive electrode and the negative electrode, such that the positive electrode and the negative electrode are electrically insulated from each other. The negative electrode, the separator, and the positive electrode can be overlaid on top of each other and rolled to form a cylindrical shape structure.

### FIELD OF THE DISCLOSURE

The present disclosure relates generally to batteries, and more particularly, relates to lithium batteries.

### BACKGROUND OF THE DISCLOSURE

Batteries, such as alkaline batteries, are commonly used as energy sources. Generally, alkaline batteries have a cathode, an anode, a separator and an alkaline electrolyte solution. The cathode includes a cathode material (e.g., manganese dioxide or nickel oxyhydroxide) and carbon particles that enhance the conductivity of the cathode. The anode includes an anode material (e.g., zinc). The separator is disposed between the cathode and the anode. The alkaline electrolyte solution, which is dispersed throughout the battery, can be an aqueous hydroxide solution such as potassium hydroxide.

Conventional alkaline batteries often have a short lifespan, especially in moderate to heavy drain applications, poor performance after a long time of storage, and often fail to function normally in extreme conditions such as in a low temperature environment, etc. Accordingly, there is a need for an improved battery that has a longer lifespan in moderate to heavy drain applications, and provides a desired performance after a long time of storage and other advantages over the conventional batteries.

### SUMMARY OF THE DISCLOSURE

The present disclosure presents system, methods, and apparatus providing improved batteries that address the limitation noted for the prior art. According to one embodiment of the present disclosure, a battery can have a cylindrical shape extending along a longitudinal central axis X. The battery can include a positive electrode, a negative electrode, a separator separating the positive electrode and the negative electrode from each other. The positive electrode and the negative electrode can be immersed respectively in an electrolyte.

The battery can further include a housing extending along the longitudinal central axis for receiving the positive electrode, the negative electrode, the separator, and the electrolyte. The housing can include a bottom end and a top end. The bottom end can be sealed by an electrically conductive material, which can be connected to the negative electrode through a current collector and serves as a negative terminal of the battery. The top end can be sealed by a seal ring. A cap, which can be made from an electrically conductive material and serves as a positive terminal of the battery, may be attached to the seal ring and electrically connected to the positive electrode through a current collector.

According to exemplary embodiments of the present disclosure, the battery may further include a positive temperature coefficient (PTC) device connected between the current collector and the positive terminal cap at the top end of the battery. The PTC device may include a positive temperature coefficient resistor, the resisitance of which increases when the temperature rises. In operation, when the PTC device reaches its activation temperature, its resistance increases rapidly. This reduces the flow of current, allowing the battery to cool. When the PTC device cools to below the activation temperature, its resistance drops to a normal level and the battery functions normally. The PTC device protects the battery from overheating if externally short-circuited, overcharged, or forced into deep discharge.

According to exemplary embodiments of the present disclosure, the negative electrode includes lithium (Li), preferably in the form of a thin sheet. The positive electrode includes copper oxide (CuO), preferably in the form of powder. In one preferred form, the copper oxide powder mixed with additives, which include, for example, but not limited to, adhesive materials and/or conductive materials (e.g., carbon black), is coated on a thin sheet substrate, which is preferably made from aluminum. Alternatively, the positive electrode may include aluminum oxide (Al₂O₃) or silver oxide (Ag₂O), instead of copper oxide. The aluminum oxide or silver oxide may also be in the form of powder coated on a thin sheet substrate. As an example, the powder(s) may be ground to a size such that the aluminum, aluminum oxide, silver, and/or silver oxide is/are present in a desired concentration, e.g., 800 ppm, or range of concentrations, e.g., 200-800+ ppm, and/or present a desired surface area. For example, the mean particulate size (e.g., diameter) can be selected such that the active material (or desired component thereof) is present at a selected level, e.g., 800 ppm.

The separator may also be in the shape of a thin sheet. The separator sheet can be sandwiched (placed) between the positive electrode and the negative electrode, such that the positive electrode and the negative electrode are electrically insulated from each other. In one preferred embodiment, the separator is made from polymer such as polypropylene. The negative electrode, the separator, and the positive electrode can be overlaid on top of each other and rolled to form a cylindrical shape structure.

The electrolyte can be a solid electrolyte or a liquid electrolyte. In one preferred embodiment, the electrolyte may include LiClO₄ dissolved in an organic solvent. In one preferred form, the organic solvent includes PC (propylene carbonate) and DEM (dimethoxyethane). In another preferred embodiment, the organic solvent includes dioxolane (DOL).

In embodiments utilizing copper oxide in the positive electrode, the positive electrode and the negative electrode can conduct electrochemical reactions according to the equations shown below:

Li^{→}Li⁺+e⁻

CuO+2e⁻_{^{→}}Cu+O²⁻

According to one aspect of the present disclosure, the battery is manufactured by a process described below. The positive material CuO is first processed to form CuO powder and mixed with additives. The CuO powder and the additives are coated on an aluminum sheet. The negative electrode (e.g., a lithium sheet), the separator, and the positive electrode sheet are overlaid on top of each other, and electrically conductive leads or tabs are connected to the positive and negative electrodes for connection with the positive and negative terminals of the battery. The multiple layers are then rolled to form a cylindrical structure.

A test circuit can be connected to the positive electrode and the negative electrode to test the battery device, especially testing whether the positive electrode and negative electrode are short-circuited. An electrically conductive sheet material is attached to the bottom end of the cylindrical structure to seal the bottom end of the cylindrical structure. The liquid electrolyte can be injected into the housing. The cap, which can be used as the positive terminal of the battery, can be prepared/formed. The PTC device can be connected to the cap and the sealing ring can be attached to the cap. The current collector for the positive electrode may be connected to the PTC device. The cap and the sealing ring can then be attached to the top end of the cylindrical housing to form a sealed battery cell. The battery can then be inspected and packed.

### BRIEF DESCRIPTION OF THE DRAWINGS

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure. In the drawings:

FIG. 1 is a schematic cross-sectional view of a battery taken along the longitudinal central axis of the battery;

FIG. 2 is a graph depicting the performance of the battery at different temperatures;

FIG. 3 is a graph depicting the performance of the battery versus the storage time under different temperatures; and

FIGS. 4A-4E show graphs each depicting the discharge performance of the battery under a constant discharge current.

It should be understood by one skilled in the art that the embodiments depicted in the drawings are illustrative and variations of those shown as well as other embodiments described herein may be envisioned and practiced within the scope of the disclosure.

### DETAILED DESCRIPTION

The present disclosure is directed to systems and methods that address the limitations of prior art batteries.

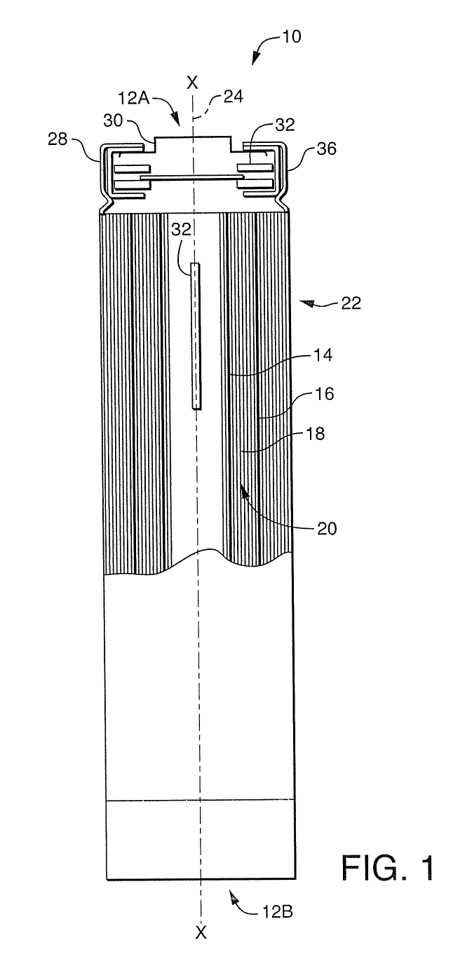

FIG. 1 schematically shows a cross-sectional view of an exemplary embodiment of the present disclosure. As shown in FIG. 1, in an exemplary embodiment, a battery 10 according to the present disclosure can have a cylindrical shape extending along a longitudinal central axis X between a top end 12A and a bottom end 12B. The battery 10 includes a positive electrode 14, a negative electrode 16, a separator 18 separating the positive electrode 14 and the negative electrode 16 from each other. The positive electrode 14 and the negative electrode 16 can be immersed, respectively, in an electrolyte 20. The battery 10 can further include a housing 22 extending along the longitudinal central axis X for receiving the positive electrode 14, the negative electrode 16, the separator 18, and the electrolyte 20.

An electrically conductive sheet material may be attached to the bottom end 12B and seals the bottom end of the housing 22, as shown. The electrically conductive sheet material at the bottom end 12B may be connected to the negative electrode 16 through a negative current collector and serves as a negative terminal of the battery 10. A seal ring 28 can be attached to the top end 12A of the housing 22 for sealing the electrodes and the electrolyte in the housing 22. A positive current collector 24 is disposed at or near the top end 12A and is connected to the positive electrode 14. A cap 30, which is made from an electrically conductive material and serves as a positive terminal of the battery 10, is attached to the seal ring 28 and electrically connected to the positive current collector 24. The battery 10 can be constructed to be a primary cylindrical battery, such as an AA battery, an AAA battery, etc.

According to one aspect of the present disclosure, the negative electrode 16 includes lithium (Li), preferably in the form of a thin sheet. The positive electrode 14 includes an active material, for example, copper oxide (CuO). An active material may be in the form of powder in exemplary embodiments. For example, copper oxide powder can be mixed with additives, which may include, but are not limited to, adhesive materials and/or electrically conductive materials (e.g., carbon black). The active material (with or without any such additives) may be coated on a thin sheet substrate. The thin sheet substrate can be made from aluminum in exemplary embodiments.

In one form, the thin sheet substrate can be constructed in a mesh shape. In another form, the thin sheet substrate can be constructed as a continuous sheet. The separator 18 is also in the shape of a thin sheet. The separator sheet 18 can be sandwiched between the positive electrode 14 and the negative electrode 16, such that the positive electrode 14 and the negative electrode 16 are electrically insulated from each other. In one preferred embodiment, the separator 18 is made from polymer such as polypropylene. The negative electrode 16, the separator 18, and the positive electrode 14 can be overlaid on top of each other, as shown, and rolled to form a cylindrical shape structure.

Alternatively, the positive electrode 14 may include aluminum oxide (e.g., Al₂O₃) or silver oxide (e.g., Ag₂O), instead of copper oxide. The aluminum oxide or silver oxide may also be in the form of powder coated on a thin sheet substrate. As an example, the powder(s) may be ground to a size such that the aluminum, aluminum oxide, silver, and/or silver oxide is/are present in a desired concentration, e.g., 800 ppm, or range of concentrations, e.g., 200-800+ ppm, and/or present a desired surface area. For example, the mean particulate size (e.g., diameter) can be selected such that the active material (or desired component thereof) is present at a selected level, e.g., 800 ppm.

The electrolyte 20 can be a solid electrolyte or a liquid electrolyte. In one preferred embodiment, the electrolyte 20 includes LiClO₄ dissolved in an organic solvent. In one preferred form, the organic solvent includes PC (propylene carbonate) and DEM (dimethoxyethane). In another preferred embodiment, the organic solvent includes dioxolane (DOL).

In exemplary embodiments utilizing copper oxide in the positive electrode, the positive electrode and the negative electrode conduct electrochemical reactions according to the equations shown below:

Li^{→}Li⁺+e⁻

CuO+2e⁻_{^{→}}Cu+O²⁻

According to an exemplary embodiment, the battery 10 may further include a pressure relief system 36 disposed at the top end 12A. The pressure relief system 36, in one preferred form, includes at least one apertures providing fluid communication between the interior of the battery 10 and the outside of the battery 10. In normal condition, the apertures are covered by a film. If the interior pressure within the battery 10 exceeds a predetermined level, the film is exploded and the interior high pressure is relieved. The pressure relief system 36 can prevent excessive pressure from building up within the battery if the battery is exposed to very high temperatures. The film covering the apertures can be a plastic film, a metal film (e.g., aluminum film), or a film made from a composite material.

According to another aspect of the present disclosure, the battery 10 may further include a re-settable thermal switch, for example, a positive temperature coefficient (PTC) device 32 connected between the current collector 24 and the cap 30 as shown in FIG. 1. The PTC device 32 may include a positive temperature coefficient resistor, the resisitance of which increases when the temperature rises. When the PTC device 32 reaches its activation temperature, its resistance increases rapidly. This reduces the flow of current, allowing the battery to cool. When the PTC 32 cools to below the activation temperature, its resistance drops to a normal level and the battery functions normally. The PTC device 32 protects the battery from overheating if externally short-circuited, overcharged or forced into deep discharge.

At least two factors can influence if or when the PTC device 32 is activated. One is the ambient temperature and the other is the internal heating that occurs as a result of discharge of the battery. The higher the rate of discharge (the heavier the drain or load on the battery), the more heat is generated. Generally, the following factors can affect the ambient temperature or the internal heating during discharge: surrounding air temperature, thermal insulating properties of the battery container, cumulative heating effects of batteries connected together, discharge rate(s) and duration(s), frequency and length of rest periods, etc.

For various embodiments, a number of other variables involved may be considered to predict in advance whether the battery can operate under certain load conditions. For example, in certain embodiments, a maximum continuous current drain can be established at 2.0 amps, however higher pulses can be achieved. A reliable method useful for determining whether the battery can operate under certain load conditions can include testing the battery with the device of interest under worst-case conditions. Moreover, a PTC device may impose some limitations on applications for which the battery is suitable, however, such a device can facilitate ensuring that a battery is safe, by protecting the battery, the equipment the battery is used with, and/or the user.

According to one aspect of the present disclosure, a battery 10 can manufactured by the following process. The positive material CuO can first be processed to form CuO powder and mixed with suitable additives. The CuO powder and the additives can then be coated on an aluminum sheet to form the positive electrode. The negative electrode (e.g., lithium sheet), the separator, and the positive electrode sheet can be overlaid on top of each other, and electrically conductive leads or tabs can be connected to the positive and negative electrodes for connection with the positive and negative terminals of the battery.

The multiple layers may then be rolled to form a cylindrical structure. A test circuit can be connected to the positive electrode and the negative electrode to test the battery device, especially testing whether the positive electrode and negative electrode are short-circuited. An electrically conductive sheet material is attached to the bottom end of the cylindrical structure to form a bottom-sealed housing. The liquid electrolyte is injected into the bottom-sealed housing. The cap, which is to be used as the positive terminal of the battery, is prepared. The PTC device is then connected to the cap and the sealing ring is attached to the cap. The current collector is connected to the PTC device. The cap and the sealing ring are then attached to the top end of the cylindrical housing to form a sealed battery cell. The battery is then inspected and packed. The above manufacturing process may also be used for batteries utilizing aluminum oxide and/or silver oxide in the positive electrode.

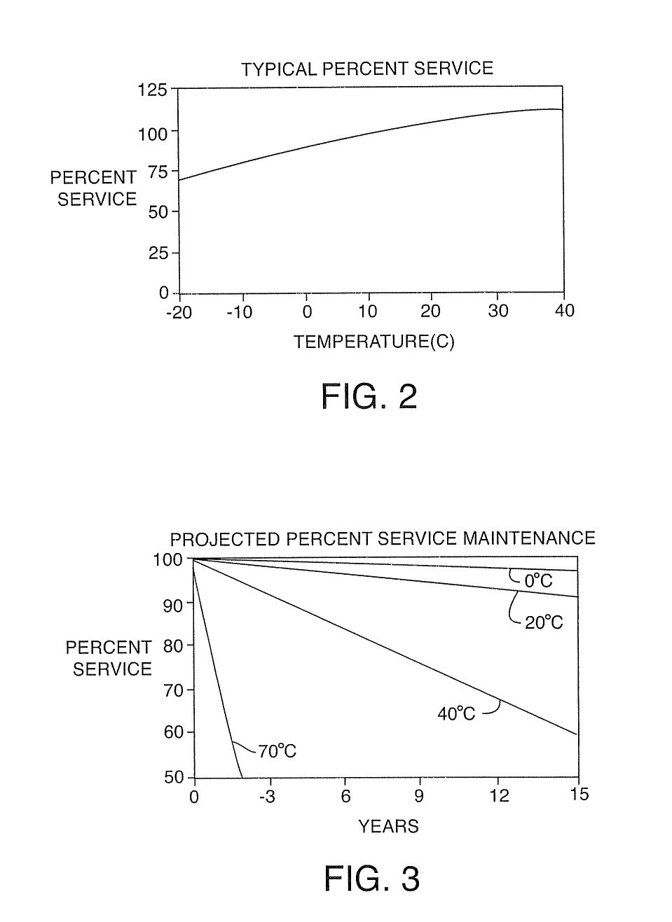

FIG. 2 illustrates a graph depicting the percentage of service (or power) that can be derived from the battery constructed according to the present disclosure as a function of the temperature of the operation environment. The point of 100 percent is the desired level of service that can be gained from the battery.

FIG. 3 illustrates a graph showing the percentage of service that can be derived from the battery after a certain time of storage at different temperatures.

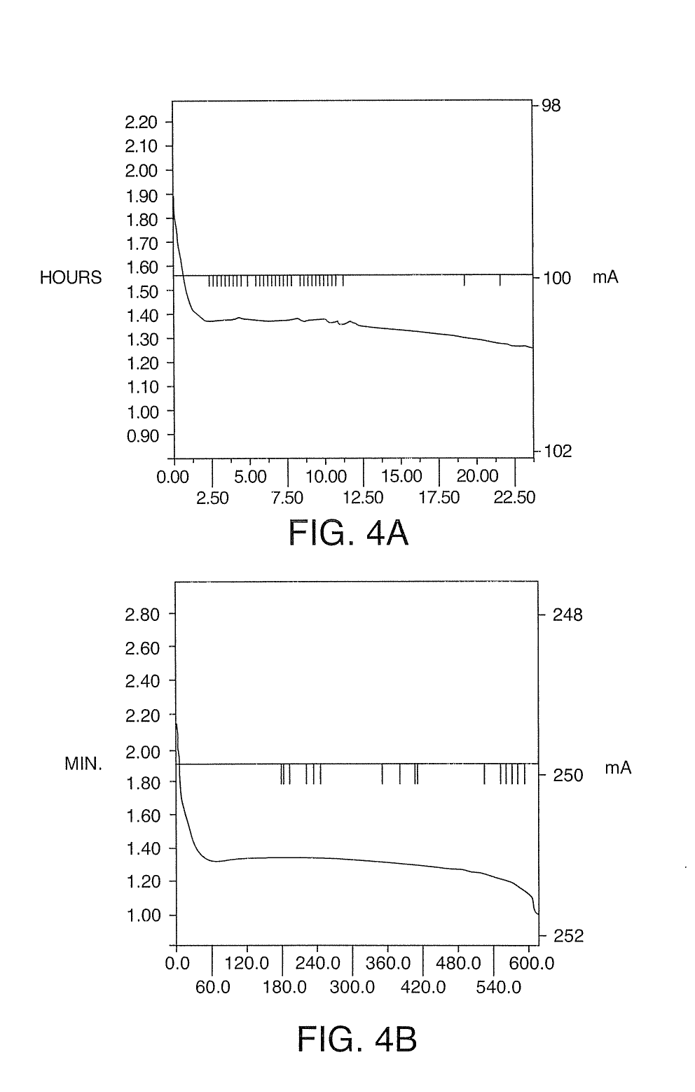

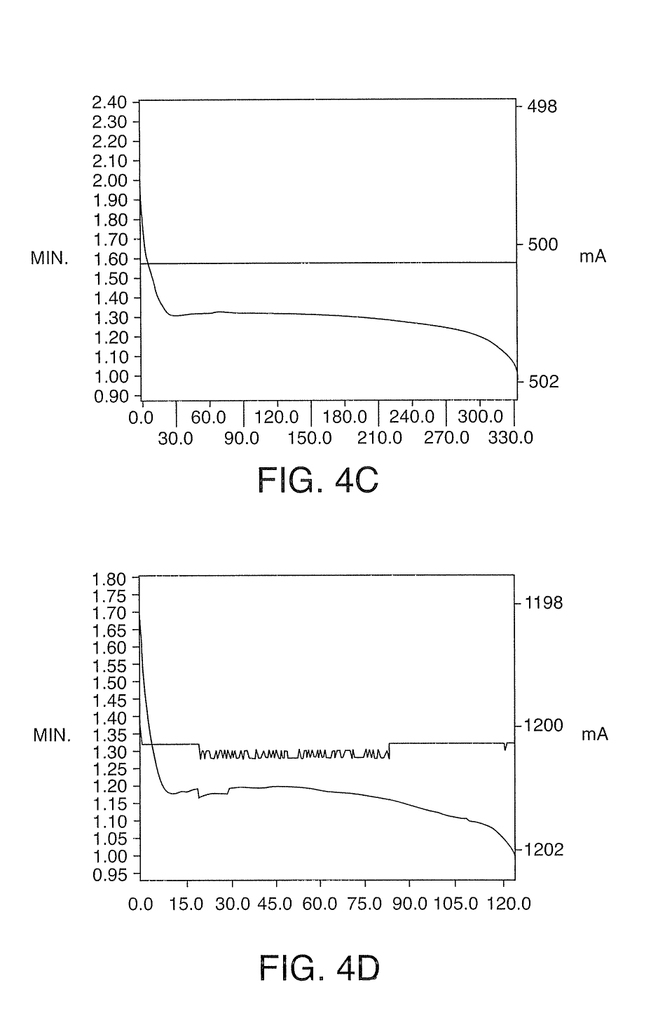

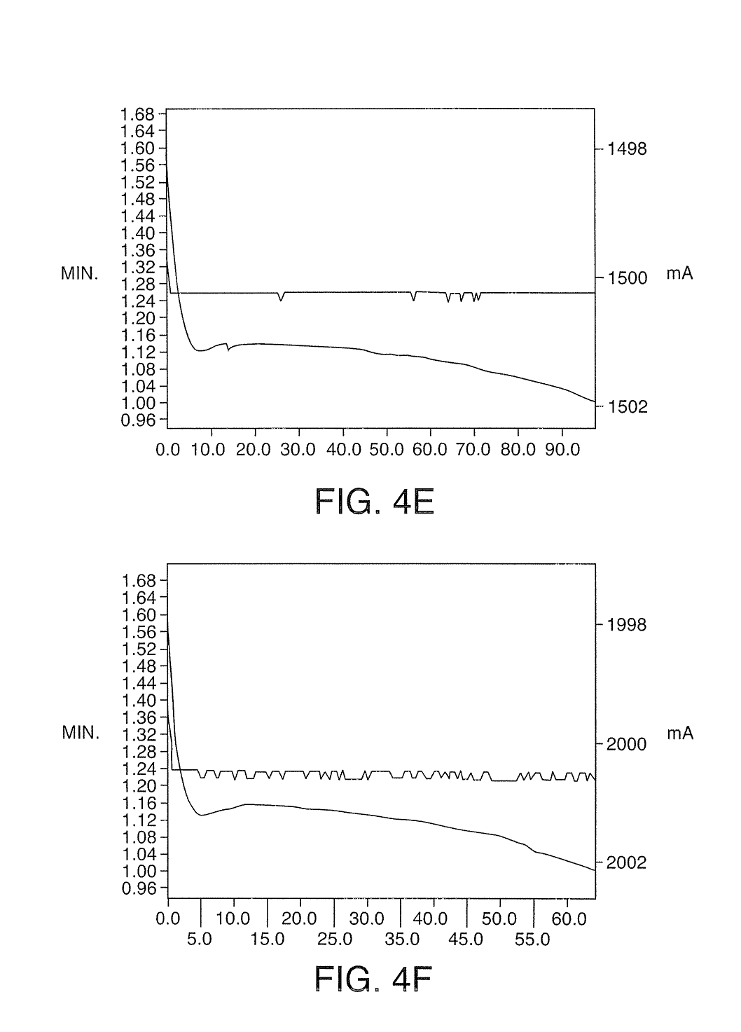

FIGS. 4A-4F illustrate graphs showing discharge curves at different discharge currents of one exemplary embodiment of the battery. For example, as shown in FIG. 4A, the discharge current is constant, which is 100 mA and the cut off voltage is 1.0V. The discharge time is 1428 minutes and the discharge capacity is 2380 mAh.

### EXAMPLES

Table 1 shows an exemplary formula for constructing the battery according to the present disclosure by reference to weight percentages.

TABLE 1

| Ingredients | Function | Percent |
|---|---|---|
| CuO | Material for Positive Electrode | 50 |
| Carbon Black | Additive for Positive Electrode | 6 |
| Li | Material of Negative Electrode | 6 |
| LiC1O4 | Material for Electrolyte | 25 |
| Others (PC, DME, | Electrolyte (solvent), Substrate for | 13 |
| aluminum foil, etc.) | Positive Electrode, etc. | |

If the ingredients or the percentage of the ingredients of the battery are changed, the battery's performance, such as capacity, internal impedance, discharging time, changes.

Table 2 shows another exemplary formula of the battery according to the present disclosure by reference to weight percentages.

TABLE 2

| Ingredient | Weight percentage |
|---|---|
| CuO | 47 |
| Carbon Black | 6 |
| Li | 6 |
| LiC1O4 | 25 |
| Others (DOL, | 16 |
| aluminum foil, etc.) | |

The battery having the ingredients shown in TABLE 2 was tested, discharging with current 1000 mA and cut off voltage 1.0V, and the discharge capacity was 2870 mAh. Table 3 (below) shows another exemplary formula of the battery according to the present disclosure by reference to weight percentages.

TABLE 3

| Ingredient | Weight percentage |
|---|---|
| CuO | 45 |
| Carbon Black | 6 |
| Li | 6 |
| LiC1O4 | 25 |
| Others (DOL, | 18 |
| aluminum foil, etc.) | |

The battery having the ingredients shown in TABLE 3 was tested, discharging with current 1000 mA and cut off voltage 1.0V, and the discharge capacity was 2872mAh. Table 4 shows another exemplary formula of the battery according to the present disclosure by reference to weight percentages.

TABLE 4

| Ingredient | Weight percentage |
|---|---|
| CuO | 41 |
| Carbon Black | 5.1 |
| Li | 6 |
| LiC1O4/DOL | 25 |
| Others (DOL, | 22.9 |
| aluminum foil, etc.) | |

The battery having the ingredients shown in TABLE 4 was tested, discharging with current 1000 mA and cut off voltage 1.0V, and the discharge capacity was 2780 mAh.

Table 5 shows another exemplary formula of the battery according to the present disclosure by reference to weight percentages.

TABLE 5

| Ingredient | Weight percentage |
|---|---|
| CuO | 50 |
| Carbon Black | 6.2 |
| Li | 6 |
| LiC1O4 | 25 |
| Others (DOL, | 12.8 |
| aluminum foil, etc.) | |

The battery having the ingredients shown in TABLE 5 was tested, discharging with current 1000 mA and cut off voltage 1.0V, and the discharge capacity was 2970 mAh.

While the claimed disclosure has been described in detail and with reference to specific embodiments thereof, it will be apparent to one of ordinary skill in the art that various changes and modifications can be made to the claimed disclosure without departing from the spirit and scope thereof. For example, while certain strengths of electrolytes have been described for the examples stated above, the strength of the electrolytes may be adjusted, e.g., increased, within the scope of the present disclosure.

Thus, for example those skilled in the art will recognize, or be able to ascertain, using no more than routine experimentation, numerous equivalents to the specific substances and procedures described herein. Such equivalents are considered to be within the scope of this disclosure, and are covered by the following claims.

What is claimed is:

1. A battery comprising:
a positive electrode including an active material selected from a group consisting of copper oxide, aluminum oxide, and silver oxide;
a negative electrode including lithium;
a separator for separating said positive electrode and said negative electrode from each other; and
an electrolyte contacting said positive electrode and said negative electrode.

2. A battery according to claim 1, wherein said positive electrode includes a sheet material, wherein said active material is in the form of powder and is coated on said sheet material.

3. A battery according to claim 2, wherein said positive electrode further comprises carbon black powder mixed with said active material powder.

4. A battery according to claim 2, wherein said sheet material comprises an aluminum sheet.

5. A battery according to claim 2, wherein said sheet material has a mesh shape.

6. A battery according to claim 2, wherein said sheet material is a continuous sheet.

7. A battery according to claim 1, wherein said negative electrode comprises a lithium sheet.

8. A battery according to claim 1, wherein said separator comprises a sheet material, which is made from a dielectric material.

9. A battery according to claim 1, wherein said separator is made from polypropylene.

10. A battery according to claim 1, wherein said electrolyte comprises LiClO₄ dissolved in an organic solvent.

11. A battery according to claim 10, wherein said organic solvent comprises propylene carbonate and dimethoxyethane.

12. A battery according to claim 10, wherein said organic solvent comprises dioxolane.

13. A battery comprising:
a positive electrode comprising a sheet material and an active material selected from a group consisting of copper oxide, aluminum oxide, and silver oxide, wherein said active material is in the form of powder coated on said sheet material;
a negative electrode comprising a sheet of lithium;
a separator comprising a sheet material sandwiched between said positive electrode and said negative electrode for separating said positive electrode and said negative electrode from each other; and
an electrolyte contacting the positive electrode and the negative electrode.

14. A battery according to claim 13 further comprises a positive temperature coefficient device connected to said positive electrode.

15. A battery according to claim 13, wherein said battery has a cylindrical shape formed by rolling said positive electrode, said separator, and said negative electrode.

16. A battery according to claim 15, wherein said cylindrical shape battery has a positive terminal end and a negative terminal end, wherein said positive terminal end includes a pressure relief system, which includes at least one apertures covered by a film.

17. A battery according to claim 13, wherein said positive electrode further comprises carbon black powder mixed with said active material powder.

18. A battery according to claim 13, wherein said sheet material of said positive electrode comprises an aluminum sheet.

19. A battery according to claim 18, wherein said sheet material has a mesh shape.

20. A battery according to claim 18, wherein said sheet material is a continuous sheet.

21. A battery according to claim 13, wherein said separator is made from polypropylene.

22. A battery according to claim 13, wherein said electrolyte comprises LiClO₄ dissolved in an organic solvent.

23. A battery according to claim 22, wherein said organic solvent comprises propylene carbonate and dimethoxyethane.

24. A battery according to claim 22, wherein said organic solvent comprises dioxolane.

25. A battery according to claim 2, wherein the mean particulate size of the powder is selected to provide a concentration of active material of about 800 ppm.
